(19) United States
(12) Patent Application Publication
(10) Pub. No.: US 2016/0196353 A1
(43) Pub. Date: Jul. 7, 2016

(54) Workflow to Automatically Engage SMES with Customers Over Multiple Social Media Platforms

(71) Applicant: Dell Products L.P., Round Rock, TX (US)

(72) Inventors: Deepak Ravishankar, Bangalore (IN); Sharmad S. Naik, Bangalore (IN); Mainak Roy, Kolkata (IN)

(73) Assignee: Dell Products L.P., Round Rock, TX (US)

(21) Appl. No.: 14/588,589

(22) Filed: Jan. 2, 2015

(51) Int. Cl. G06F 17/30; G06Q 50/00

(52) U.S. Cl. CPC G06F 17/30867; G06F 17/3097; G06Q 50/01; G06F 17/30539; G06F 17/30876

(57) ABSTRACT

A system, method, and computer-readable medium are disclosed for improved management of unattended user queries. An unattended user query management system is implemented to detect an unattended user query in a social media environment. Data associated with the unattended user query is then retrieved from the social media environment and processed to assign the unattended user query to a predetermined category. Once the unattended user query has been categorized, it is provided to a resource, such as a subject matter expert (SME), associated with the query. In response, an answer to the previously-unattended user query is received from the resource, which is then provided to the social media environment that was the source of the unattended user query.

### BACKGROUND OF THE INVENTION

1. Field of the Invention

The present invention relates to the management of information handling systems. More specifically, embodiments of the invention provide a system, method, and computer-readable medium for improved management of unattended user queries.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The widespread availability of such information handling systems has been instrumental in the adoption of social media into the mainstream of everyday life. Social media commonly refers to the use of web-based technologies for the creation and exchange of user-generated content for social interaction. An increasingly popular use of social media is to provide a channel for customer feedback and support. One aspect of customer support is responding to customer queries in a timely manner. Providing a prompt and useful answer to customer queries not only increases customer satisfaction, but brand loyalty as well.

Traditional methods of measuring customer satisfaction in a social media environment include determining a Net Promoter Score (NPS). NPS is a customer loyalty metric intended to reduce the complexity of implementation and analysis frequently associated with measures of customer satisfaction with the objective of creating more “Promoters” and fewer “Detractors.” As such, NPS can provide a stable measure of business performance that can be compared across business units while increasing interpretability of changes in customer satisfaction trends over time. Accordingly, failure to respond in a prompt, positive and helpful manner to unattended queries can have a negative effect on a vendor's NPS.

However, the distributed nature of social media environments creates various challenges. For example, current approaches to managing answers to customer queries involve individually monitoring each social media venue. Furthermore, the growing number of such venues has made it progressively more difficult to detect relevant customer queries as they are generated. Moreover, once a customer query is detected, it is often time consuming to first identify, and then engage, the most knowledgeable resource, such as a subject matter expert (SME), to respond to the query. As a result, it is not uncommon for user queries to go unattended in a social media environment for lengthy periods of time.

### SUMMARY OF THE INVENTION

A system, method, and computer-readable medium are disclosed for improved management of unattended user queries. In various embodiments, an unattended user query management system is implemented to detect an unattended user query in a social media environment. In these embodiments, data associated with the unattended user query is retrieved from the social media environment and then processed to assign the unattended user query to a predetermined category. Once the unattended user query has been categorized, it is provided to a resource, such as a subject matter expert (SME), associated with the query. In response, an answer to the previously-unattended user query is received from the resource, which is then provided to the social media environment that was the source of the unattended user query.

In various embodiments, the retrieved data associated with the unattended user query may include the Uniform Resource Locator (URL) of the unattended user query, a social media identifier (e.g., a forum name), a description of the unattended user query, of details associated with the unattended user query. In certain embodiments, the category an unattended user query is assigned to may include a social media environment, a market segment, a line of business (LOB), a product line, an individual product, a use of a product, a problem associated with a product, a provided service, a class of user, or a topic of user interest.

In various embodiments, the unattended user query is provided to the resource in a communication format. In these embodiments, the communication format may include an email message, an Instant Messenger (IM) message, a Short Message Service (SMS) message, or some combination thereof. In certain embodiments, identity information associated with the resource providing the answer is appended to the answer prior to it being provided to the social media environment that was the source of the unattended user query.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the system and method of the present invention;

FIG. 2 is a simplified block diagram of an unattended user query management system;

FIG. 3 is a simplified block diagram of an unattended user query management system implemented to manage unattended user queries;

FIG. 4 is a generalized flowchart of the performance of operations to initialize an unattended user query management system;

FIG. 5 is a generalized flowchart of the performance of operations to detect and then retrieve unattended user queries from a social media environment;

FIG. 6 is a generalized flowchart of the performance of operations to categorize unattended user queries;

FIG. 7 is a generalized flowchart of the performance of operations to forward unattended user queries to a predetermined resource for an answer; and

FIG. 8 is a generalized flowchart of the performance of operations to provide answers to previously unattended user queries.

### DETAILED DESCRIPTION

A system, method, and computer-readable medium are disclosed for improved management of unattended user queries. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

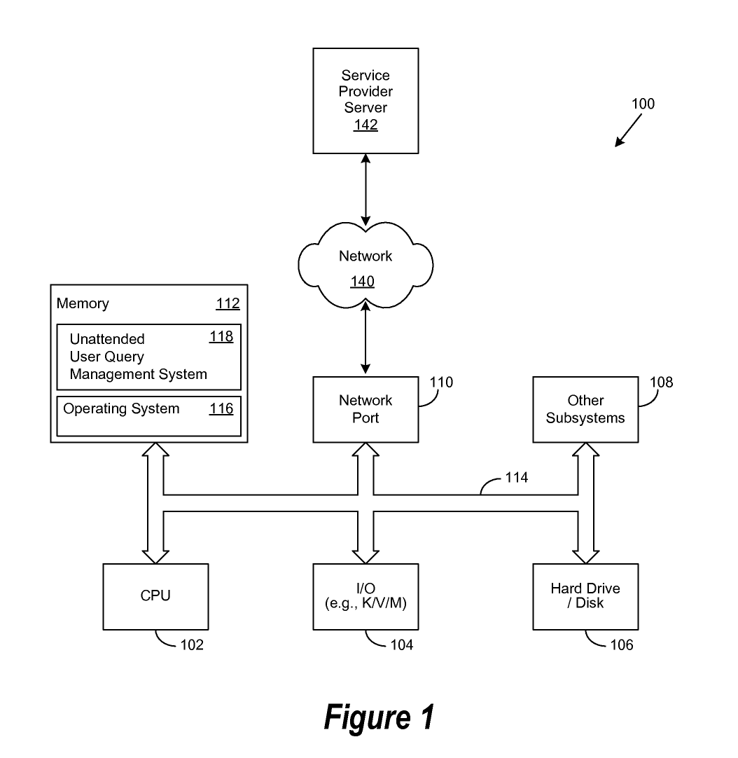

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise an unattended user query management system 118. In one embodiment, the information handling system 100 is able to download the unattended user query management system 118 from the service provider server 142. In another embodiment, the unattended user query management system 118 is provided as a service from the service provider server 142.

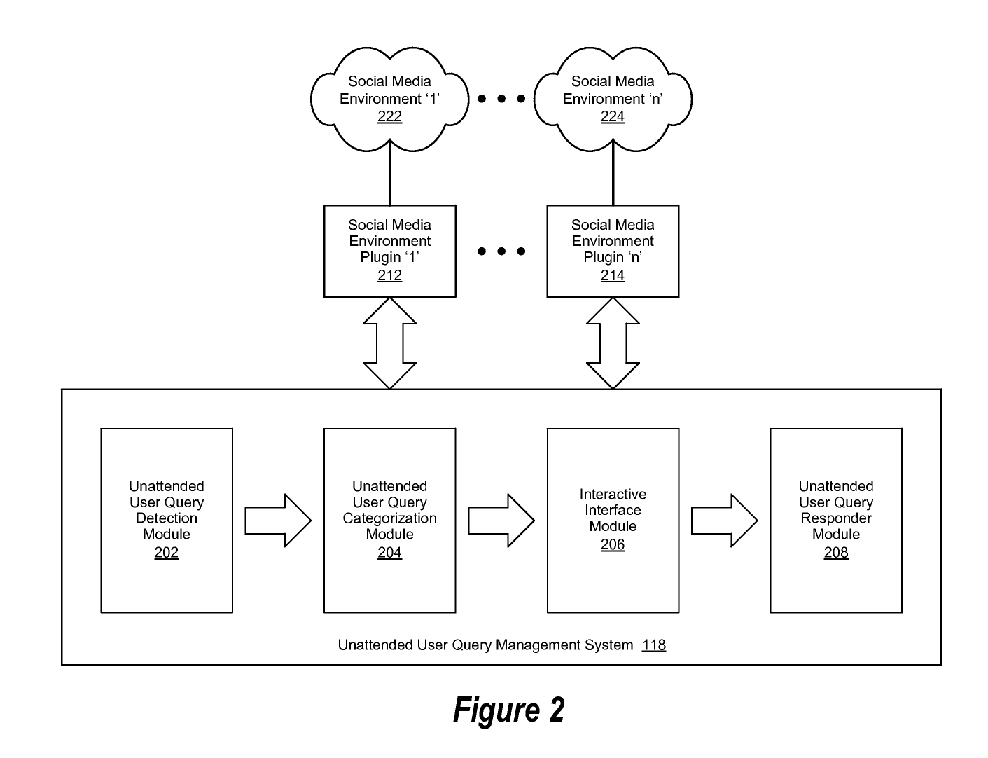

FIG. 2 is a simplified block diagram of an unattended user query management system implemented in accordance with an embodiment of the invention. As used herein, an unattended user query broadly refers to a query posted in a social media environment that has not yet received attention, or been attended to, by an individual or organization whose responsibility it is to provide an answer. More particularly, a query that has been attended to may not have received an answer as the answer may still be in the process of being provided. As such, an unattended user query that is in the process of being attended to may also be an unanswered query.

In this embodiment, social media environment plugins ‘1’ 212 through ‘n’ 214 are implemented with an unattended user query management system 118 to respectively monitor interactions conducted within a target social media environments ‘a’ 222 through ‘n’ 224 that may indicate a relevant unattended user query. As an example, a social media interaction may contain an explicit unattended user query, such as, “I posted a request for the forum moderator to provide information on how to resolve my problem, but have yet to get an answer.” In this example, the user has declaratively stated that a request was made, but no answer has been received, which may be considered relevant to the moderator of the forum. As another example, a social media interaction may contain an implicit unattended user query, such as, “While I have posted all of the symptoms of my issue, no one in the group has responded with any suggestions.” In this example, no formal request for assistance has been made, yet the user still has not received an answer in the form of guidance or suggestions, which may be considered relevant to other members of the group who may be able to provide suggestions.

In these embodiments, the social media environment plugins ‘1’ 212 through ‘n’ 214 collect data associated with an unattended user query when such an interaction is respectively detected in the social media environments ‘1’ 222 through ‘n’ 224. The collected data is then provided to the unattended user query management system 118 for processing. In certain embodiments, a web service is implemented with the social media environment plugins ‘1’ 212 through ‘n’ 214 to monitor its associated social media environments ‘1’ 222 through ‘n’ 224, detect an unattended user query, and collect associated data. In various embodiments, a separate social media environment plugin ‘1’ 212 through ‘n’ 214 is implemented for each social media environment ‘1’ 222 through ‘n’ 24 that is monitored. The method by which individual social media environment plugins ‘1’ 212 through ‘n’ 214 and their associated web services are implemented, and an unattended user query is detected and its associated data is collected and provided to the unattended user query management system 118, is a matter of design choice.

In various embodiments, unattended user query management operations are initiated by first initializing the unattended user query management system 118, followed by initializing an associated database for each social media environment plugins ‘1’ 212 through ‘n’ 214. In various embodiments, one or more databases may be implemented with the unattended user query management system 118. As an example, different databases may be implemented to support various web services implemented with a particular social media environment plugin ‘1’ 212 through ‘n’ 214. The one or more databases selected for implementation, and the method by which they are implemented and initiated for each social media environment plugin ‘1’ 212 through ‘n’ 214, is a matter of design choice.

Once all social media environment plugins ‘1’ 212 through ‘n’ 214 have been initialized in the database, the unattended user query management system 118 waits for the various web services implemented with their associated social media environment plugins ‘1’ 212 through ‘n’ 214 to exit. The polling interval for the unattended user query management system 118 is then set, followed by the initialization of a thread for each social media environment plugin ‘1’ 212 through ‘n’ 214 to query its associated web service. As used herein, the polling interval refers to how often each social media environment plugin ‘1’ 212 through ‘n’ 214 queries its associated web service for unattended user query data. The method by which the polling interval is selected and implemented is a matter of design choice.

In various embodiments, the unattended user query management system 118 may include an unattended user query identifier module 202, an unattended user query categorization module 204, an interactive interface module 206, and an unattended user query responder module 208. In this embodiment, the unattended user query identifier module 202 is implemented such that each social media environment plugin ‘1’ 212 through ‘n’ 214 generates a query to contact its associated web service. Once contacted, each web service is respectively queried by its associated social media environment plugin ‘1’ 212 through ‘n’ 214 to detect unattended queries and retrieve associated data from the social media environments ‘1’ 222 through ‘n’ 224.

In various embodiments, the retrieved data is in an Extensible Markup Language (XML) format. The retrieved data is then parsed by the unattended user query detection module 202 to determine various associated information, such as the unattended user query's Uniform Resource Locator (URL), a social media identifier corresponding to the social media environment associated with the unattended user query, a description of the unattended user query, and its details. The particular information parsed from the retrieved data is a matter of design choice. The retrieved unattended user query, along with its parsed information, is then stored in its respective table for its associated social media environment in a database associated with the unattended user query management system 118.

The unattended user query categorization module 204 is then implemented to select a database table respectively associated with a target social media environment ‘1’ 222 through ‘n’ 224. Once the database table is selected, unattended queries and their associated data are identified. The unattended queries in the selected table, along with their associated data, are then processed by the unattended user categorization module 204 to categorize the unattended queries into predetermined categories. In various embodiments, the categories may include a predetermined social media environment (e.g., social media environments ‘1’ 222 through ‘n’ 224), a market segment, a line of business (LOB), a product line, an individual product, a use of a product, a problem associated with a product, a provided service, a class of user, or a topic of user interest.

In certain embodiments, the categorization of the unattended queries is performed by using predetermined key words (e.g., keywords), social media environment identifiers (e.g., forum IDs), or social media user affiliation (e.g., social media groups that a user may be affiliated with) associated with the unattended user query. Those of skill in the art will realize that many such embodiments are possible, and the foregoing is not intended to limit the spirit, scope or intent of the invention. The selection of the predetermined categories, and the method by which the unattended queries are categorized, is a matter of design choice.

The interactive interface module 206 is then implemented to determine which resource, such as a subject matter expert (SME), will be responsible for responding to each of the previously-identified unattended queries. In various embodiments, the resource is assigned to unattended queries according to the social media environment associated with each unattended user query. In certain embodiments, the resource is assigned according to the category associated with each unattended user query. The method by which a resource is selected to respond to each unattended user query is a matter of design choice. Those of skill in the art will recognize that many such embodiments are possible and the foregoing is not intended to limit the spirit, scope or intent of the invention.

The unattended queries are then forwarded by the interactive interface module 206 for delivery to their associated SME. In various embodiments, the unattended queries are formatted in a predetermined communication format for delivery to their associated SME. In certain embodiments, the communication format may be an email message, an Instant Messenger (IM) message, a Short Message Service (SMS) message, or a combination thereof. The method by which the unattended queries are formatted in a predetermined communication format, and then forwarded for delivery to the SME, is a matter of design choice. Skilled practitioners of the art will realize that many such embodiments are possible and the foregoing is not intended to limit the spirit, scope or intent of the invention.

Once it is determined that each SME has attended to their associated unattended queries, answers to previously-unattended queries are updated in the database and queries that are still unattended are time stamped by the interactive interface module 206. In various embodiments, identification information associated with the SME (e.g., user name, Active Directory or Lightweight Directory Access Protocol user name, etc.) is associated with the answer to each query in the database that has been attended to. In certain embodiments, once an unattended user query has been attended to, it is marked accordingly in the database. The method by which the SME is identified, and the method by which an unattended user query is marked as having been attended to, is a matter of design choice. In one embodiment, an unattended user query is no longer visible to others once it has been attended to.

The unattended user query responder module 208 is then implemented to check the database for answers to previously unattended queries, followed by marking previously unattended queries corresponding to the answers as “attended.” Each answer is then updated by the unattended user query responder module 208 with the identity of the subject Matter Expert (SME) that respectively responded to each previously unattended user query.

Each answer is then redirected to the web service respectively associated with the social media environment ‘1’ 222 through ‘n’ 224 that was the source of the unattended user query. In various embodiments, the data associated with the unattended user query, such as its Uniform Resource Locator (URL) and social media identifier (ID), is used to redirect the answer to the appropriate web service. In certain embodiments, the answer is redirected to multiple web services, each of which is respectively associated with social media environments ‘1’ 222 through ‘n’ 224, if it is expected that the same query may be posted by users of other social media environments. As an example, an SME may realize in the course of responding to an unattended user query that it will it likely be made by other users. In this example, the SME may proactively decide to post the answer to multiple social media environments, such as social media environments ‘1’ 222 through ‘n’ 224. In turn, each previously unattended user query and its answer is then redirected by the appropriate web service to its associated social media environment ‘1’ 222 through ‘n’ 224.

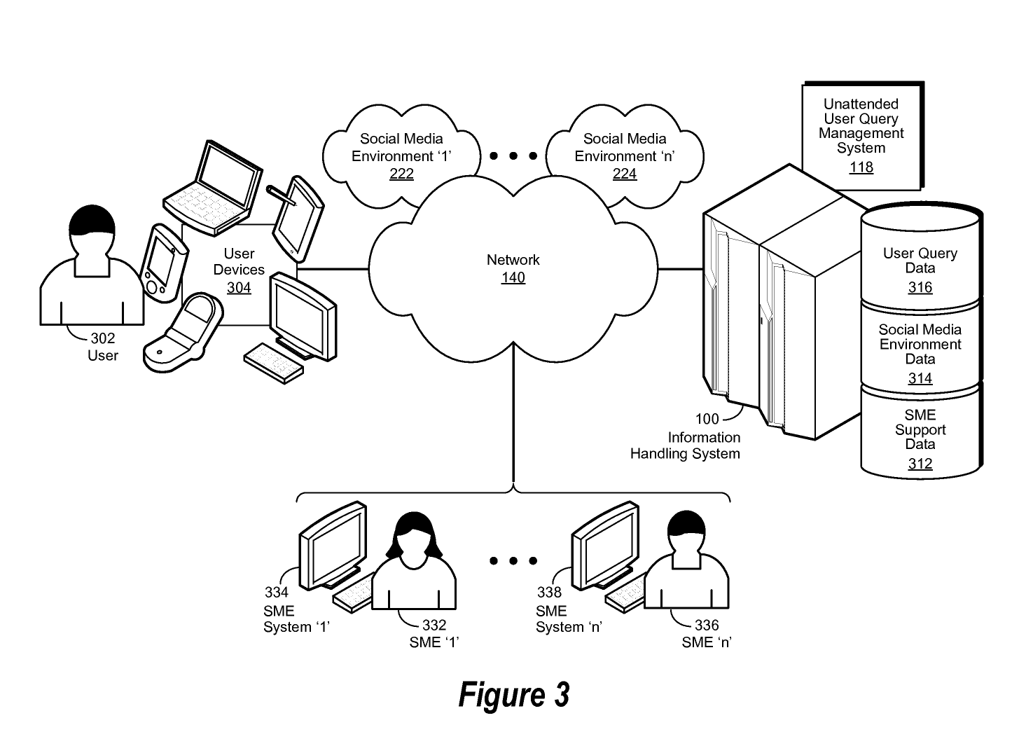

FIG. 3 is a simplified block diagram of an unattended user query management system implemented in accordance with an embodiment of the invention to manage unattended user queries. In various embodiments, a user 302 may post a query to a social media environment ‘a’ 222 through ‘n’ 224, which in turn may become an unattended user query when it has not received attention, or been attended to, by an individual or organization whose responsibility it is to provide an answer. In these and other embodiments, the user 302 may use a user device 304 to post the query to a social media environment ‘a’ 222 through ‘n’ 224.

As used herein, a user device 304 refers to an information handling system such as a personal computer, a laptop computer, a tablet computer, a personal digital assistant (PDA), a smart phone, a mobile telephone, or other device that is capable of communicating and processing data. In various embodiments, the user device 304 is used to exchange information between the user 302 and a social media environment ‘a’ 222 through ‘n’ 224 through the use of a network 140. In certain embodiments, the network 140 may be a public network, such as the Internet, a physical private network, a wireless network, a virtual private network (VPN), or any combination thereof. Skilled practitioners of the art will recognize that many such embodiments are possible and the foregoing is not intended to limit the spirit, scope or intent of the invention.

In this embodiment, an unattended user query management system 118 is implemented on an information handling system 100 to respectively monitor interactions conducted within a target social media environment ‘a’ 222 through ‘n’ 224 that may indicate an unattended user query. In various embodiments the information handling system 100 may include repositories of subject matter expert (SME) support data 312, social media environment data 314, and user query data 316. In these various embodiments, the network 140 is used by the unattended user query management system 118 to monitor the social media environments ‘1’ 222 through ‘n’ 224 for unattended queries and to retrieve associated data.

The retrieved data is then parsed to determine various associated information, such as the unattended user query's Uniform Resource Locator (URL), a description of the query, and its details. The retrieved unattended user query, along with its parsed information, is then stored in a database associated with the unattended user query management system 118. In various embodiments, the retrieved unattended user query, along with its parsed information, may be stored in the repositories of social media environment data 314, and user query data 316. The unattended queries, along with their associated data, are then processed by the unattended user query management system 118 to categorize the unattended queries into predetermined categories.

The unattended user query management system 118 then determines which resource, such as a subject matter expert (SME) ‘1’332 through ‘n’ 336, will be responsible for responding to each of the previously-identified unattended queries. The unattended queries are then forwarded for delivery to their associated SME ‘1’ 332 through ‘n’ 336 to generate a response, such as an answer. In various embodiments, the unattended queries are formatted in a predetermined communication format for delivery to their associated SME. In certain embodiments, the communication format may be an email message, an Instant Messenger (IM) message, a Short Message Service (SMS) text, and so forth. In these and other embodiments, the network 140 is used by the unattended user query management system 118 to deliver the unattended queries to SME systems ‘1’ 334 through ‘n’ 338 respectively associated with SME ‘1’ 332 through ‘n’ 336.

Each SME ‘1’ 332 through ‘n’ 336 then respectively attends to their associated unattended queries. In various embodiments, the repository of SME support data 312 may be used by an SME ‘1’ 332 through ‘n’ 336 in the course of attending to their associated unattended queries. Once it is determined that each SME ‘1’ 332 through ‘n’ 336 has attended to their associated unattended queries, answers to previously-unattended queries are updated in the database and queries that are still unattended are time stamped. In various embodiments, identification information associated with the SME ‘1’ 332 through ‘n’ 336 (e.g., user name, Active Directory or Lightweight Directory Access Protocol user name, etc.) is associated with the answer to each query in the database that has been attended to. In certain embodiments, once an unattended user query has been attended to, it is marked accordingly in the database, such as the repository of user query data 316.

Each answer to a previously-unattended user query is then redirected, as described in greater detail herein, to the social media environment ‘1’ 222 through ‘n’ 224 that was the source of the unattended user query. In various embodiments, the data associated with the unattended user query, such as its Uniform Resource Locator (URL) and social media identifier (ID), is used to redirect the answer to the appropriate social media environment ‘1’ 222 through ‘n’ 224. In these and other embodiments, the network 140 is used by the unattended user query management system 118 to redirect the answer to the appropriate social media environment ‘1’ 222 through ‘n’ 224.

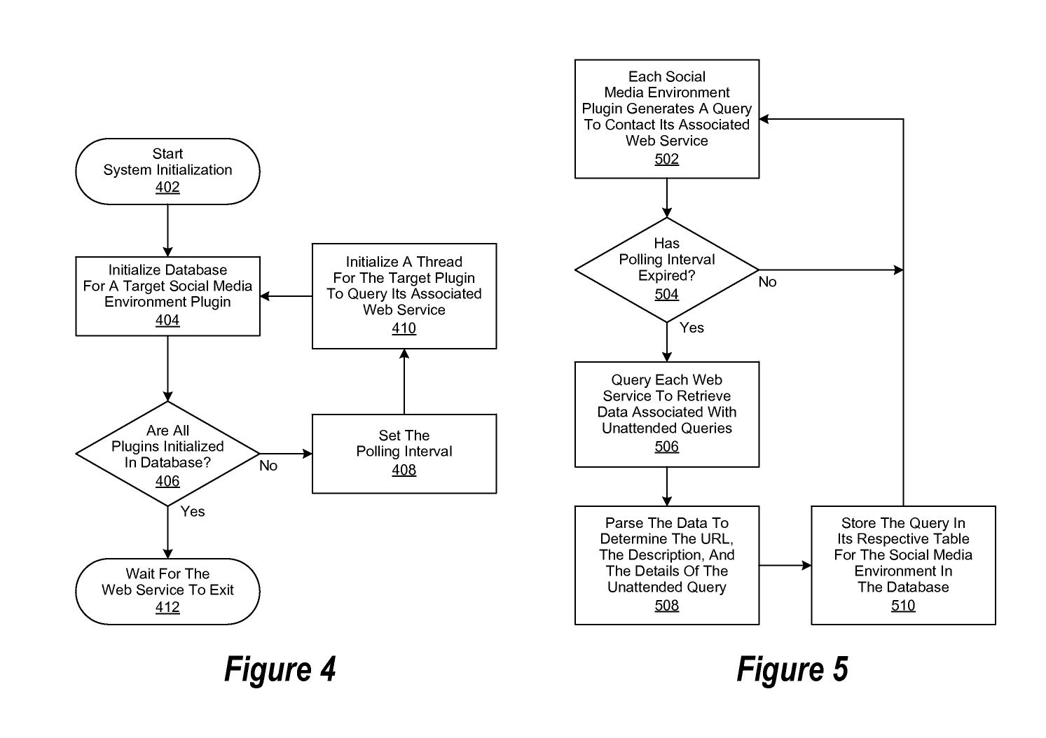

FIG. 4 is a generalized flowchart of the performance of operations implemented in accordance with an embodiment of the invention to initialize an unattended user query management system. In various embodiments, a social media environment plugin is implemented with an unattended user query management system to monitor interactions conducted within a target social media environment that may indicate a relevant unattended user query. In these embodiments, the social media environment plugin collects data associated with the unattended user query when such an interaction is detected and provides it to the unattended user query management system for processing. In certain embodiments, a web service is implemented with the social media environment plugin to monitor its associated social media environment, detect an unattended user query, and collect associated data.

In this embodiment, an unattended user query management system, described in greater detail herein, is initialized in step 402, followed by initializing an associated database for a target social media environment plugin in step 404. A determination is then made in step 406 whether all social media environment plugins implemented with the unattended user query management system have been initialized in the database. If so, then the unattended user query management system waits in step 412 for the various web services implemented with their associated social media environment plugins to exit. Otherwise, the polling interval for the social media environment plugin is set in step 408, followed by the initialization of a thread for the target plugin to query its associated web service in step 410. The process is then continued, proceeding with step 404.

FIG. 5 is a generalized flowchart of the performance of operations implemented in accordance with an embodiment of the invention to detect and retrieve unattended user queries from a social media environment. In this embodiment, each social media environment plugin generates a query in step 502 to contact its associated web service, followed by a determination being made in step 504 whether the respective polling interval for each social media environment plugin has expired. If not, then the process is continued, proceeding with step 502. Otherwise, each web service is queried by its associated social media environment plugin in step 506 to detect unattended queries and retrieve associated data from its associated social media environment. The retrieved unattended user query, along with its parsed information, is then stored in its respective table for its associated social media environment in the database in step 510. The process is then continued, proceeding with step 502.

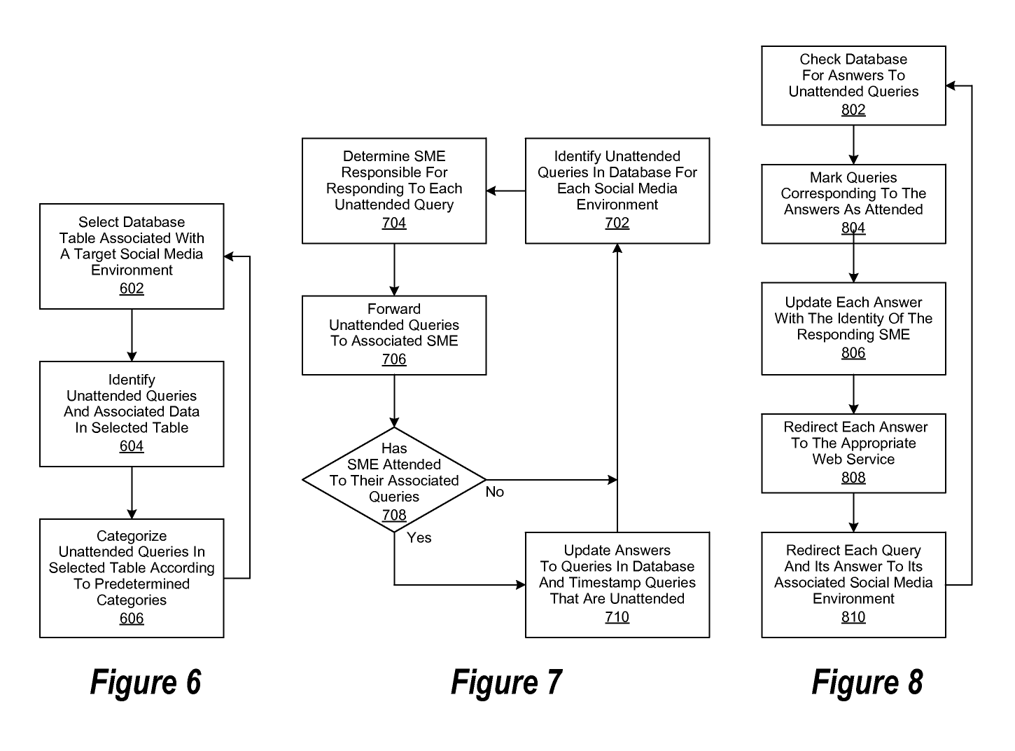

FIG. 6 is a generalized flowchart of operations performed in accordance with an embodiment of the invention to categorize unattended queries into predetermined categories for subsequent processing. In this embodiment, a database table associated with a target social media environment is selected in step 602, followed by the identification of unattended queries, and associated data, in step 604. The unattended queries in the selected table, along with their associated data, are then processed in step 606 to categorize them into predetermined categories. The process is then continued, proceeding with step 602.

FIG. 7 is a generalized flowchart of the performance of operations implemented in accordance with an embodiment of the invention to forward unattended user queries to a predetermined resource for an answer. In this embodiment, unattended queries in the database are identified in step 702, followed by determining the resource, such as a subject matter expert (SME), responsible for responding to each unattended user query in step 704.

The unattended queries are then forwarded for delivery to their associated SME in step 706. A determination is then made in step 708 whether each SME has attended to their associated unattended queries. If not, then the process is continued, proceeding with step 702. Otherwise, answers to previously-unattended queries are updated in the database and queries that are still unattended are time stamped in step 710. The process is then continued, proceeding with step 702.

FIG. 8 is a generalized flowchart of the performance of operations implemented in accordance with an embodiment of the invention to provide answers to previously unattended user queries. In this embodiment, the database is checked for answers to previously unattended queries in step 802, followed by marking previously unattended queries corresponding to the answers as attended in step 804. Each answer is then updated in step 806 with the identity of the subject Matter Expert (SME) that respectively responded to each previously unattended user query. Each answer is then redirected in step 808 to the web service respectively associated with the social media environment that was the source of the unattended user query. In turn, each previously unattended user query and its answer is then redirected by the appropriate web service to its associated social media environment in step 810 and the process is continued, proceeding with step 802.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A computer-implementable method for improved management of unattended user queries, comprising:
detecting an unattended user query in a social media environment;
retrieving data associated with the unattended user query from the social media environment;
processing the retrieved data to assign the unattended user query to a category;
providing the unattended user query to a resource associated with the category;
receiving an answer to the unattended user query from the resource; and
providing the answer to the social media environment that was the source of the unattended user query.

2. The method of claim 1, wherein the data associated with the unattended user query comprises at least one member of the set of:
the Uniform Resource Locator (URL) of the unattended user query;
a social media identifier of the social media environment associated with the unattended user query;
a description of the unattended user query; and
details associated with the unattended user query.

3. The method of claim 1, wherein the category is at least one member of the set of:
a social media environment;
a market segment;
a line of business (LOB);
a product line;
an individual product;
a use of a product;
a problem associated with a product;
a provided service;
a class of user; and
a topic of user interest.

4. The method of claim 1, wherein the unattended user query is provided to the resource in a communication format comprising at least one member of the set of:
an email message;
and Instant Messenger (IM) message; and
a Short Message Service (SMS) message.

5. The method of claim 1, wherein the resource is a subject matter expert (SME).

6. The method of claim 1, wherein identity data associated with the resource is appended to the answer.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations for improved management of unattended user queries and comprising instructions executable by the processor and configured for:
detecting an unattended user query in a social media environment;
retrieving data associated with the unattended user query from the social media environment;
processing the retrieved data to assign the unattended user query to a category;
providing the unattended user query to a resource associated with the category;
receiving an answer to the unattended user query from the resource; and
providing the answer to the social media environment that was the source of the unattended user query.

8. The system of claim 7, wherein the data associated with the unattended user query comprises at least one member of the set of:
the Uniform Resource Locator (URL) of the unattended user query;
a social media identifier of the social media environment associated with the unattended user query;
a description of the unattended user query; and
details associated with the unattended user query.

9. The system of claim 7, wherein the category is at least one member of the set of:
a social media environment;
a market segment;
a line of business (LOB);
a product line;
an individual product;
a use of a product;
a problem associated with a product;
a provided service;
a class of user; and
a topic of user interest.

10. The system of claim 7, wherein the unattended user query is provided to the resource in a communication format comprising at least one member of the set of:
an email message;
and Instant Messenger (IM) message; and
a Short Message Service (SMS) message.

11. The system of claim 7, wherein the resource is a subject matter expert (SME).

12. The system of claim 7, wherein identity data associated with the resource is appended to the answer.

13. A non-transitory, computer-readable storage medium embodying computer program code, the computer program code comprising computer executable instructions configured for:
detecting an unattended user query in a social media environment;
retrieving data associated with the unattended user query from the social media environment;
processing the retrieved data to assign the unattended user query to a category;
providing the unattended user query to a resource associated with the category;
receiving an answer to the unattended user query from the resource; and
providing the answer to the social media environment that was the source of the unattended user query.

14. The non-transitory, computer-readable storage medium of claim 13, wherein the data associated with the unattended user query comprises at least one member of the set of:
the Uniform Resource Locator (URL) of the unattended user query;
a social media identifier of the social media environment associated with the unattended user query;
a description of the unattended user query; and
details associated with the unattended user query.

15. The non-transitory, computer-readable storage medium of claim 13, wherein the category is at least one member of the set of:
a social media environment;
a market segment;
a line of business (LOB);
a product line;
an individual product;
a use of a product;
a problem associated with a product;
a provided service;
a class of user; and
a topic of user interest.

16. The non-transitory, computer-readable storage medium of claim 13, wherein the unattended user query is provided to the resource in a communication format comprising at least one member of the set of:
an email message;
and Instant Messenger (IM) message; and
a Short Message Service (SMS) message.

17. The non-transitory, computer-readable storage medium of claim 13, wherein the resource is a subject matter expert (SME).

18. The non-transitory, computer-readable storage medium of claim 13, wherein identity data associated with the resource is appended to the answer.
